(19) United States
(12) Patent Application Publication
(10) Pub. No.: US 2009/0014304 A1
(43) Pub. Date: Jan. 15, 2009

(54) Key sheet

(75) Inventor: Fumitaka Arai, Tokyo (JP)

Correspondence Address: CERMAK KENEALY & VAIDYA, LLP, 515 EAST BRADDOCK RD SUITE B, Alexandria, VA, 22314, US

(73) Assignee: Polymatech Co., Ltd., Tokyo (JP)

(21) Appl. No.: 12/216,491

(22) Filed: Jul. 7, 2008

(30) Foreign Application Priority Data
Jul. 9, 2007 (JP) 2007-180139

(51) Int. Cl. H01H 13/14

(52) U.S. Cl. 200/341

(57) ABSTRACT

A thin-film-like key sheet covering pushbutton switches is equipped with a plurality of key tops constituting operating pushbuttons, and a film-like base sheet on an upper surface of which the key tops are placed, in which a depression load is small, and no interference with the adjacent key tops and a frame sheet occurs when depressing the key tops, thus avoiding undulating movement of those components. There is further provided a film-like shape maintaining sheet covering a lower surface of a base sheet and stacked on the base sheet, and the shape maintaining sheet has, at dividing positions between the adjacent key tops, insulating slits insulating a stress generated along a surface of the shape maintaining sheet when the key tops are depressed. Thus, the key tops do not easily rise or become shaky at a time of depressing operation.

### BACKGROUND OF THE INVENTION

1. Field of the Invention

The present invention relates to key sheet covering pushbutton switches for use in operating portions of various apparatuses such as mobile phones, PDAs, car navigation apparatuses, and car audio apparatuses.

2. Description of the Related Art

For use in a mobile phone, there is known, a key sheet in which, for a reduction in size of an operating portion and an improvement in terms of an artistic design of the pushbutton switch, a plurality of key tops are exposed in a dense state through an operational opening with no partition frame, which is formed in a casing. For example, a mobile phone 1 illustrated in FIG. 17 uses a key sheet 2 as illustrated in FIGS. 18A through 19 allowing input operation. In the key sheet 2, in order to diminish the size of the input operation surface, a total of twenty key tops 4 are arranged at small intervals on a base sheet 3 formed of silicone rubber and fixed in position by adhesive 5. The base sheet 3 is reinforced by a frame-shaped reinforcing member 6 formed of hard resin, and it is possible to prevent deflection of the entire key sheet 2 when solely the periphery of the key sheet 2 is fixed to an operational opening 1a of the mobile phone 1. An example of the key sheet 2 is disclosed in JP 2005-63795 A.

Further, there has been developed a key sheet 7 as illustrated in FIGS. 20 and 21 which is thinner and lighter than the key sheet 2 and superior thereto in terms of design property. In the key sheet 7, flake-like key tops 9 and a film-like frame sheet 10 are arranged on the operation surface side of a base sheet 8 formed of a resin film, and are fixed thereto by a printed adhesive layer 11. Unlike the above-mentioned key sheet 2, the key sheet 7 has no reinforcing member 6; however, instead of the base sheet 3 formed of silicone rubber, there is used the base sheet 8 formed of a resin film. Thus, when compared with the structure formed solely by the rubber-like base sheet 3, it is possible to suppress deflection of the key sheet 7 as a whole. An example of the key sheet 7 is disclosed in JP 2007-66818 A.

As described above, in the key sheet 7 using the base sheet 8 formed of a resin film, it is possible to suppress deflection of the key sheet 7 as a whole; however, when depressing key tops 9, there is a fear of the depressed key tops 9 and the key tops 9 adjacent thereto moving in the operation surface direction in an undulating manner or being shaky, making it in some cases rather difficult to perform input operation.

### SUMMARY OF THE INVENTION

It is accordingly an object of the present invention to provide a key sheet which, while reduced in thickness, does not involve a large depression load and which, when key tops are depressed, is relatively free from interference with the key tops and frame sheet adjacent thereto, thus facilitating input operation.

In order to achieve the above-mentioned object, the present invention provides a key sheet including: a plurality of key tops; a base sheet having the key tops fixed on an upper surface thereof, with the key sheet being mounted onto a board having contact input portions; and the key sheet further including a film-like shape maintaining sheet stacked on and fixed to a back surface of the base sheet, in which the shape maintaining sheet has depressing portions for depressing the contact input portions respectively in correspondence with the key tops, and insulating slits provided between the adjacent depressing portions, for insulating a stress generated in a surface direction of the shape maintaining sheet when the key tops are depressed.

In the present invention, on the back surface of the base sheet, there is further provided a film-like shape maintaining sheet stacked on and fixed to the base sheet, and hence it is not only possible to reinforce the base sheet and maintain the form of the key sheet as a whole but also to make the base sheet relatively free from deflection in the surface direction (direction along the sheet surface). Thus, when depressing key tops, the depressed key tops and the key tops adjacent thereto do not easily move in an undulating manner in the operation surface direction. The key tops do not easily rise or become shaky, making it possible to accurately perform input operation. Further, the bottom surfaces of the key tops are also covered with the shape maintaining sheet, and the key tops are not placed on the holed portions of the shape maintaining sheet via the base sheet only. Thus, few portions of the base sheet undergo deformation, and hence the base sheet does not easily suffer rupture. Thus, it is possible to use a base sheet thinner than those conventionally used. When there are no holes or grooves extending through the sheet thickness of the base sheet, the base sheet can serve as a seal member when the key sheet is mounted to an apparatus, thus making it possible to obtain waterproof and dust-proof effects.

Further, the shape maintaining sheet is provided with depressing portions for depressing contact input portions respectively in correspondence with the key tops. In addition, there are provided between the adjacent depressing portions insulating slits for insulating a stress generated in the surface direction of the shape maintaining sheet when the key tops are depressed, and hence the shape maintaining sheet can be easily deflected in the depressing direction. Thus, it is possible to reduce the depression load, and, in the case of a switch with a tactile feel, it is possible to enhance the tactile feel for the operator. In this way, in the key sheet of the present invention, it is possible to enhance the rigidity in the surface direction without impairing the depression operability. The “depressing portions” refer to the portions of the shape maintaining sheet depressing the contact input portions respectively in correspondence with the key tops. When the portions depressing the contact input portions are formed of pushers provided on the shape maintaining sheet, those pushers constitute the depressing portions. When no pushers in particular are provided, the portions of the shape maintaining sheet corresponding to the contact input portions constitute the depressing portions. Further, even when the shape maintaining sheet is not brought into direct contact with the contact input portions as in the case in which further stacking is effected on the back surface of the shape maintaining sheet, the portions of the shape maintaining sheet which indirectly depress the contact input portions and which are nearest to the contact input portions constitute the depressing portions.

Further, in the present invention, it is possible to provide a key sheet in which there is further provided on the upper surface of the base sheet a frame sheet arranged with the key tops. Due to the provision of this frame sheet, it is possible to enhance the decoration property of the entire key sheet and the shape maintaining property of the entire key sheet. While this frame sheet may be provided as a member corresponding to the outer frame of the key tops, it is not always necessary for the frame sheet to exist around each and every key top. That is, the present invention also includes a form in which a plurality of key tops are arranged at narrow intervals, with no frame sheet existing between the adjacent key tops.

The base sheet may be formed as an elastic film with rubber elasticity having a thickness of 150 μm or less. By forming the base sheet of an elastic film with rubber elasticity having a thickness of 150 μm or less, it is possible to meet the requirement for a reduction in the thickness of the key sheet and to achieve a reduction in the number of components. Further, unlike a film that is simply flexible, due to its rubber elasticity, this base sheet helps to reduce the depression load, thereby achieving an improvement in terms of operability.

Further, it is possible for the thickness of the shape maintaining sheet to range from 25 μm to 250 μm, and for the maximum thickness of the key sheet as measured from the key tops to the shape maintaining sheet to be 1.0 mm or less. When the thickness of the shape maintaining sheet is less than 25 μm, the rigidity of the shape maintaining sheet in the surface direction is rather low, and it is difficult to maintain the shape in the surface direction of the base sheet. Thus, when the key tops are depressed, the key sheet is allowed to move in the surface direction in an undulating manner. When the thickness of the shape maintaining sheet exceeds 250 μm, the total thickness of the key sheet is rather large due to the large thickness of the shape maintaining sheet, and the mounting of the thin key sheet on an apparatus is rather difficult, with the depression load being rather high, and hence there is a fear of the depression operability being impaired. Since the thickness of the shape maintaining sheet ranges from 25 μm to 250 μm, and the maximum thickness of the key sheet as measured from the key tops to the shape maintaining sheet is 1.0 mm or less, it is possible to provide a key sheet which, while thin, has a satisfactory depression operability, is free from malfunction of the adjacent keys, and is of small depression load.

The insulating slits of the shape maintaining sheet may be formed in a tongue-like configuration in plan view of the shape maintaining sheet. Due to the formation of the insulating slits in a tongue-like configuration, it is possible to make the portions divided by the insulating slits free from detachment from the shape maintaining sheet at the tongue proximal portions, making it possible to cancel the constraint from the periphery at the tongue-like portions. Further, when depressing the key tops, interference between the key tops, such as undulating movement or shaking of the adjacent key tops, does not easily occur, making it possible to obtain a key sheet of a satisfactory depressing operation feel whose depression load is small.

The insulating slits of the shape maintaining sheet may be provided at four-side positions corresponding to the square configuration of the key top in plan view of the shape maintaining sheet except for two or more apex portions. Since the insulating slits are provided at four-side positions corresponding to the square configuration of the key tops except for two or more apex portions, it is possible to make the portions divided by the insulating slits free from detachment from the shape maintaining sheet at two or more apex portions, making it possible to cancel the constraint from the periphery at the four-side portions. Further, it is possible to provide a key sheet of a satisfactory depression operating feel in which, when depressing the key tops, there occurs no interference between the key tops, such as undulating movement or shaking of the adjacent key tops, with the depression load being of a level which is not to be regarded as large. In this case, the “apex portions” refer to the four apex portions of the square configuration, and the expression “except for two or more apex portions” means that any two to four apex portions of the four apex portions are to be excluded. Further, the expression: “corresponding to the square configuration” includes the case in which it is identical with the square configuration.

Further, the insulating slits may be within the lower projections of the key tops on the shape maintaining sheet. Since the insulating slits are within the lower projections of the key tops on the shape maintaining sheet, it is possible to freely change the configuration and size of the insulating slits independently of the key top configuration. As a result, it is possible to adjust, for example, the ease with which the depressing operation is performed.

Further, the insulating slits may be provided between the depressing portions corresponding to the dividing positions of the adjacent key tops. Since the insulating slits are provided between the depressing portions corresponding to the dividing positions of the adjacent key tops, it is possible to make the shape maintaining sheet easy to deflect in the depressing direction. In this case, the expression: “the dividing positions of the adjacent key tops” refers to the boundaries dividing the adjacent key tops from each other; when the key tops are adjacent to each other at small intervals, and the boundary portions are in the form of lines, those lines are the boundaries; and, when the key tops are spaced apart from each other and the boundary portion is of a width, that width portion is the boundary. Further, it is not necessary for all the dividing positions of the adjacent key tops to have the insulating slits; it is only necessary for a part of the dividing positions to be provided with insulating slits.

Further, the fixation portions between the shape maintaining sheet and the base sheet may be provided at inner positions surrounded by the insulating slits in plan view of the shape maintaining sheet. Since the fixation portions between the shape maintaining sheet and the base sheet are provided at inner positions surrounded by the insulating slits in plan view of the shape maintaining sheet, it is possible to provide each insulating slit within the projection thereof on the bottom surface of the corresponding key top without allowing it to stick out of the projection. Thus, it is possible to enhance the reinforcing effect of the shape maintaining sheet. In this case, the expression “in plan view” means the plan views of the key sheet as given in the accompanying drawings.

Alternatively, the fixation portions between the shape maintaining sheet and the base sheet may be provided at outer positions surrounded by the insulating slits in plan view of the shape maintaining sheet. Further, it is also possible to provide the fixation portions on the portions excluding the insulating slits, that is, over the entire surface of the shape maintaining sheet facing the base sheet. This also helps to insulate the stress in the surface direction, making the shape maintaining sheet easy to deflect in the depressing direction. Thus, it is possible to reduce the depression load, making it possible to enhance the tactile feel for the operator in the case of tactile switches. In this way, in the key sheet of the present invention, it is possible to enhance the rigidity in the surface direction without impairing the depression operability.

The present invention has been made after much trial and error. First, an attempt was made to suppress undulating deformation of the base sheet and the key tops fixed thereto by simply increasing the thickness of the base sheet. As a result, it was found that while simply increasing the thickness of the base sheet helped to suppress the undulating deformation, it involved a large depression load, resulting in a rather poor operability.

Further, in the key sheet of the present invention, the bonding portions between the key tops, the frame sheet, the shape maintaining sheet, and the base sheet may be formed of printed adhesive layers. When compared with a case in which adhesive is dripped, printed adhesive layers are relatively free from variation in the positions and area of the adhesive layers, making it possible to reliably effect the fixation. The printed adhesive layers may be brought into contact with the shape maintaining sheet, the base sheet, etc. in a “softened or molten state”. More specifically, they are brought into contact with the components in a softened or molten state before curing of the printed adhesive. Alternatively, they are brought into contact with the components in a softened or molten state attained through heating after the adhesive is printed and once cured. Thus, the printed adhesive layers help to prevent the adhesive from widely flowing and expanding in the surface direction of the sheet when bonding together the key tops, the frame sheet, the shape maintaining sheet, and the base sheet.

Further, the printed adhesive layers can be formed on the surface of the shape maintaining sheet facing the base sheet except for the groove edge sides of the insulating slits. As a result, it is possible to provide clearance portions devoid of printed adhesive layers around the insulating slits of the shape maintaining sheet, utilizing the clearance portions as the non-constraint regions of the base sheet. Thus, when the key tops are depressed, the base sheet can be easily deflected in the depressing direction, making it possible to reliably perform depressing operation on the key tops. When clearance portions are generated in the shape maintaining sheet, a wide portion of the shape maintaining sheet can be fixed to the base sheet, and there is scarcely any fear of detachment of the shape maintaining sheet.

Further, it is possible to provide an apparatus having a casing with an operational opening having in its outer side edge a mounting recess, to which the outer periphery of the shape maintaining sheet of the key sheet of one of the above-mentioned aspects of the invention is fixed to thereby provide an apparatus equipped with the above-mentioned key sheet. This makes it possible to realize an apparatus in which there are mounted thin pushbutton switches of superior depression operability.

In the key sheet of the present invention, the base sheet can be made relatively free from deflection in the surface direction, and, when depressing key tops, it is possible to make it hard for the depressed key tops and the key tops adjacent thereto to move in an undulating manner in the operation surface direction and to be shaky. Thus, it is possible to perform input operation accurately, making it possible to realize a key sheet allowing easy depressing operation. Further, due to the provision of the insulating slits, the shape maintaining sheet is easily deflected in the depressing direction. Thus, it is possible to reduce the depression load; and, in the case of a switch with a tactile feel, it is possible to enhance the tactile feel for the operator. Thus, in the key sheet of the present invention, it is possible to enhance the rigidity in the surface direction without impairing the depression operability.

The present invention is not restricted to what has been described above; the advantages, features, and uses of the present invention become more apparent from the following description given with reference to the accompanying drawings. Further, it should be understood that all the appropriate modifications made without departing from the gist of the present invention are to be covered by the scope of the present invention.

### BRIEF DESCRIPTION OF THE DRAWINGS

In the accompanying drawings:

FIG. 1 is an external view of a mobile phone with a key sheet according to a first embodiment of the present invention illustrated in FIG. 2 mounted therein;

FIG. 2 is a plan view of the key sheet of the first embodiment;

FIG. 3 is a sectional view taken along the line III-III of FIG. 2;

FIGS. 4A and 4B are plan views of a shape maintaining sheet used in the key sheet of the first embodiment, of which FIG. 4A is an explanatory view illustrating a key top fixation portion, and FIG. 4B is an explanatory view illustrating the fixation portion of the shape maintaining sheet;

FIG. 5 is a plan view of an example of the shape maintaining sheet to be used in a first modification of the first embodiment;

FIG. 6 is a plan view of another example of the shape maintaining sheet to be used in the first modification of the first embodiment;

FIG. 7 is a plan view of still another example of the shape maintaining sheet to be used in the first modification of the first embodiment;

FIG. 8 is a plan view of a key sheet according to a third modification of the first embodiment;

FIG. 9 is a sectional view taken along the line IX-IX of FIG. 8;

FIG. 10 is a sectional view, corresponding to FIG. 3, of a key sheet according to a second embodiment of the present invention;

FIGS. 11A and 11B are plan views of a shape maintaining sheet used in the key sheet of the second embodiment, of which FIG. 11A is an explanatory view illustrating a key top fixation portion, and FIG. 11B is an explanatory view illustrating the fixation portion of the shape maintaining sheet;

FIG. 12 is a sectional view, corresponding to FIG. 3, of a key sheet according to a first modification of the second embodiment;

FIGS. 13A and 13B are plan views of a shape maintaining sheet used in the key sheet of the first modification of the second embodiment, of which FIG. 13A is an explanatory view illustrating a key top fixation portion, and FIG. 13B is an explanatory view illustrating the fixation portion of the shape maintaining sheet;

FIG. 14 is a sectional view, corresponding to FIG. 3, of a key sheet according to a second modification of the second embodiment;

FIGS. 15A and 15B are plan views of a shape maintaining sheet used in the key sheet of the second modification of the second embodiment, of which FIG. 15A is an explanatory view illustrating a key top fixation portion, and FIG. 15B is an explanatory view illustrating the fixation portion of the shape maintaining sheet;

FIGS. 16A and 16B are explanatory views illustrating a key sheet evaluation method, of which FIG. 16A is a plan view of a key sheet with a measurement jig fixed thereto, and FIG. 16B is a side view of a measurement device illustrating a measurement method;

FIG. 17 is an external view of a mobile phone with a conventional key sheet mounted therein;

FIG. 18A and 18B are explanatory views of a conventional key sheet, of which FIG. 18A is a plan view of the key sheet and FIG. 18B is a back side view of the key sheet;

FIG. 19 is a sectional view taken along the line XIX-XIX of FIG. 18A;

FIG. 20 is a plan view of another conventional key sheet; and

FIG. 21 is a sectional view taken along the line XXI-XXI of FIG. 20.

### DETAILED DESCRIPTION OF THE PREFERRED EMBODIMENTS

In the following, embodiments of the present invention are described with reference to the drawings. In the drawings, the reference symbols indicate portions and components. Regarding the members, materials, constructions, manufacturing method, effects, etc. common to the embodiments, a redundant description thereof is omitted.

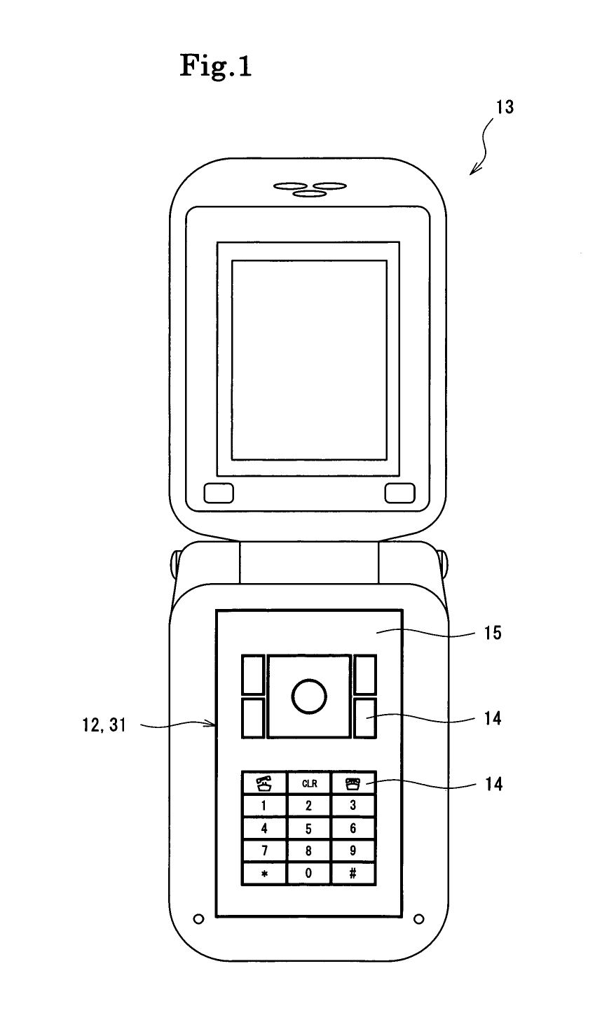

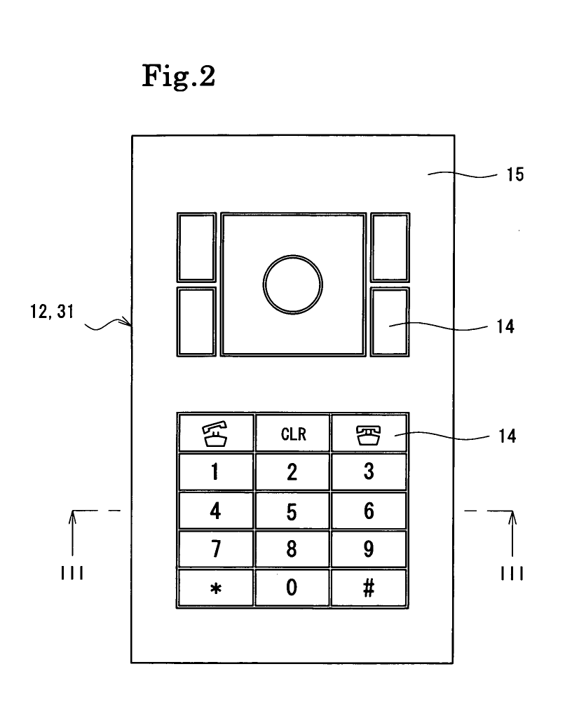

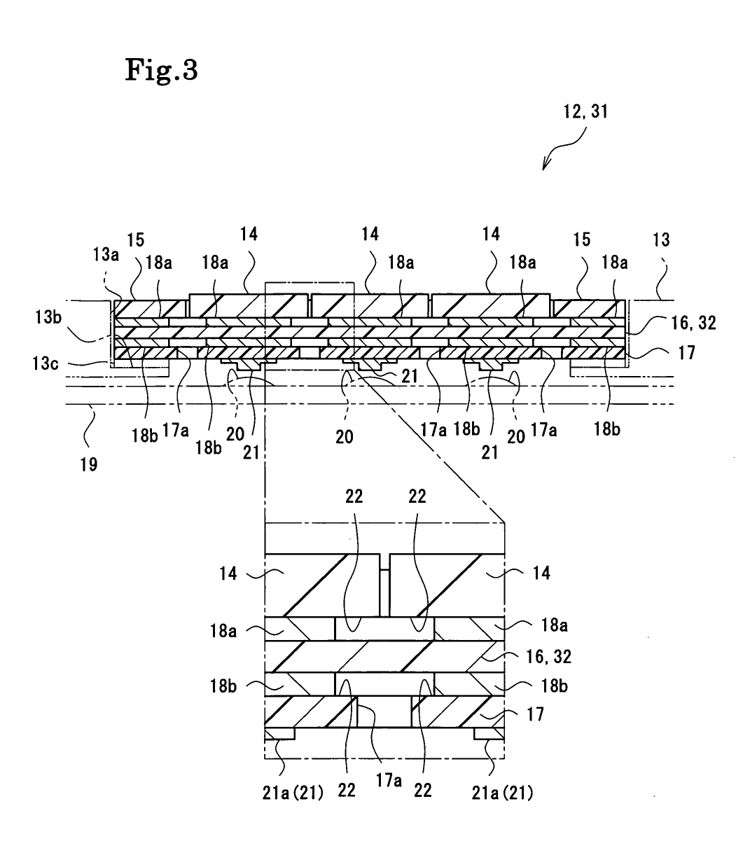

First Embodiment (FIGS. 1 through 3): FIGS. 1 through 3 illustrate a key sheet 12 according to a first embodiment of the present invention. FIG. 1 is an external view of a mobile phone 13 with the key sheet 12 mounted therein, FIG. 2 is a plan view of the key sheet 12, and FIG. 3 is a sectional view of the key sheet 12. The key sheet 12 of the first embodiment is equipped with a plurality of flake-like key tops 14 serving as operating pushbuttons, a film-like frame sheet 15 constituting the outer frame of the key tops 14, a film-like base sheet 16 on the upper surface of which the key tops 14 and the frame sheet 14 are placed, and a film-like shape maintaining sheet 17 covering the lower surface of the base sheet 16 and stacked on the base sheet 16.

The key tops 14 are operating pushbuttons for performing depressing input operation on the pushbutton switches; they are equipped with display portions representing characters, figures, symbols, etc. and formed of moldings of hard resin. The key tops 14 are arranged at narrow intervals so as to be adjacent to each other. When a so-called illumination type key sheet is adopted in order that visual recognition of the display portions even in the dark may be facilitated, the key tops 14 are formed of a translucent hard resin.

The frame sheet 15 is provided for the purpose of preventing extreme rising of the key tops 14, hiding the molding marks of the key tops 14, protecting the bonding portions between the key tops 14 and the base sheet 16, etc., and, from the viewpoint of decoration, it is possible to provide a colored layer or an evaporation layer. The frame sheet 15 is formed of a resin film in a configuration filling the gaps between the key tops 14 and an opening edge of an operational opening 13a and the gaps between the key tops 14. In the case of an illumination type key sheet, the frame sheet 15 may be formed of a light shielding resin film or the frame sheet 15 may be provided with a light shielding layer so that no light leakage through the frame sheet 15 may occur.

The base sheet 16 is a base portion on which the key tops 14 and the frame sheet 15 are placed and to which they are fixed; together with the frame sheet 15 and a shape maintaining sheet 17 described below, the base sheet 16 maintains the shape of the key sheet 12 as a whole. Further, at the time of depressing operation on the key tops 14, the base sheet 16 undergoes deflecting deformation to allow depression of contacts provided on a board (not shown). Further, the base sheet 16 is formed of a film-like member with no holes or grooves extending through the thickness thereof and has, on the upper surface (operation surface) side thereof, the key tops 14 and the frame sheet 15 bonded thereto by printed adhesive layers 18a described below. Since the base sheet 16 is provided with no holes or grooves extending through the thickness thereof, it can function as a seal member, and can exhibit a waterproof effect and a dust-proof effect. In the case of an illumination type key sheet, the base sheet 16 is formed of a translucent resin film; further, it may be provided with a colored layer, a light guiding layer, etc.

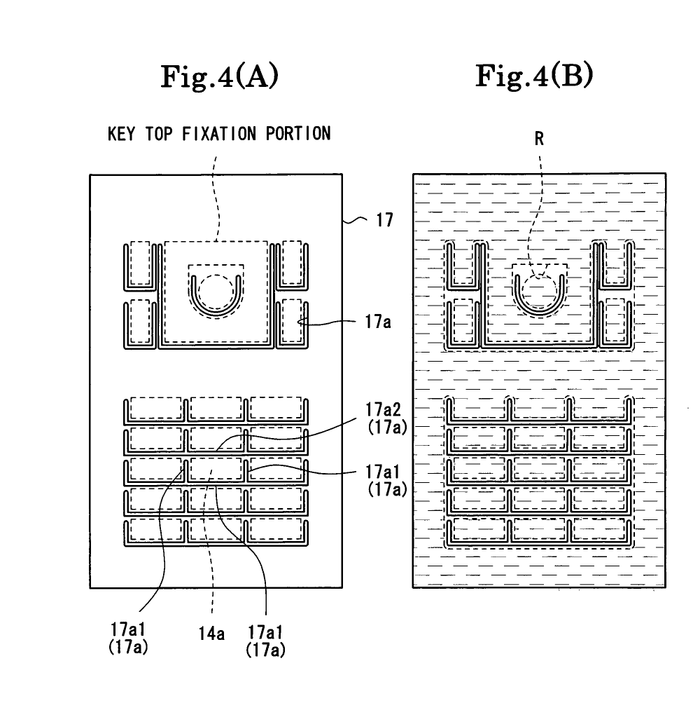

The shape maintaining sheet 17 is a member for preventing undulating movement of the key sheet 12 when, for example, the key tops 14 are moved in a direction crossing the depressing input operation direction and helping to improve the anti-distortion property of the key sheet 12 as a whole. The shape maintaining sheet 17 is formed of a resin film and is stacked on and fixed to the base sheet by printed adhesive layers 18b at least at the lower projection positions of the key tops 14. The shape maintaining sheet 17 is provided with pushers 21 constituting depressing portions for depressing contact input portions (contact switches) 20 provided on a board 19 in correspondence with the key tops 14. The pushers 21 is described below. Further, between the adjacent depressing portions 21, there are provided insulating slits for insulating a stress generated in the surface direction of the shape maintaining sheet 17 when the key tops 14 are depressed. More specifically, insulating slits extending through the thickness of the shape maintaining sheet 17 are provided at the portions of the shape maintaining sheet 17 corresponding to the dividing positions of the adjacent key tops 14. As illustrated in FIG. 4A, the insulating slits are formed as dividing grooves 17a dividing in a tongue-like fashion the portions of the base sheet 16 to which the key tops 14 are fixed.

For example, at a portion 14a illustrated in FIG. 4 of the shape maintaining sheet, which is at a position corresponding to the key top 14 with the number “5” in FIG. 2, there is provided a tongue-shaped dividing groove 17a1, which divides the key top 14 with the number “5” from the key tops 14, 14, 14 with the number “4”, “8”, and “6”, respectively. Further, at the position where the key top 14 with the number “5” is divided from the key top 14 with the number “2”, there is provided a dividing groove 17a2 situated above the dividing groove 17a1. With this construction, there are provided the insulating slits 17a at the four-side portions of the square configuration of the key top 14 with the number “5” except for the upper right portion and the upper left portion of the square configuration, insulating the stress generated through depression of the key top 14 with the number “5” and making it possible to weaken the interference with this key top 14 from the adjacent key tops 14.

On the surface of the shape maintaining sheet 17 facing the board 19, there are provided the pushers 21 for depressing the contact input portions 20 provided on the board 19. The pushers 21 are formed of ultraviolet curable resin or the like. Further, at their proximal ends fixed to the shape maintaining sheet 17, there are formed annular flange portions 21a protruding outwards. Due to this configuration of the pushers 21, it is possible to increase the fixation area of the pushers 21 with respect to the shape maintaining sheet 17, making it possible to enhance the fixation force of the pushers 21. In the case of an illumination type key sheet, they may be formed of translucent resin films. Further, it is also possible to provide a colored layer and a light guiding layer.

The printed adhesive layers 18a are layers for fixing the key tops 14 and the frame sheet 15 to the base sheet 16, and the printed adhesive layers 18b are layers for fixing the shape maintaining sheet 17 to the base sheet 16, and those printed adhesive layers are formed through printing. The printed adhesive layers 18a for fixing the key tops 14 are formed to be somewhat smaller than the bottom surfaces of the key tops 14, and between the outer edges of the bottom surfaces of the key tops 14 and the base sheet 16, there are provided gap clearance portions 22 where no printed adhesive layers 18a exist. Further, between the base sheet 16 and the edge of the frame sheet 15 adjacent to the key tops 14, there is formed no printed adhesive layer 18a for fixing the frame sheet 15, and a clearance portion 22 is also provided at this portion. Further, no printed adhesive layers 18b for fixing the shape maintaining sheet 17 are formed around the dividing grooves 17a of the shape maintaining sheet 17, and clearance portions 22 are also provided at those portions. In this embodiment, the fixation area of the printed adhesive layers 18a and the fixation area of the printed adhesive layers 18b are substantially equal to each other. FIG. 4B illustrates a fixation portion R between the shape maintaining sheet 17 and the base sheet 16. In the case of an illumination type key sheet, it is formed by using a translucent adhesive ink.

In this case, the material and thickness of each component of the key sheet 12 of the first embodiment of the present invention are described. The key tops 14 are formed of a hard resin such as thermosetting resin or thermoplastic resin. Examples of the hard resin include polycarbonate resin, ABS resin, acrylic resin, polyester resin, PBT resin, and alloy type resin thereof. In order to realize a thin key sheet, it is desirable for the thickness of the key tops 14 to range from 100 μm to 600 μm. When it is less than 100 μm, the key tops 14 are subject to cracking, and when it exceeds 600 μm, the key sheet 12 as a whole is rather thick, which does not help to meet the requirement for a reduction in thickness. In a more preferred mode, the thickness is 400 μm.

The frame sheet 15 is formed of a resin film of high wear resistance. Examples of the resin film include polyethylene terephthalate film, polybutylene terephthalate film, polyurethane film, polyamide film, polypropylene film, polystyrene film, fluoropolymer film, ionomer film, polycarbonate film, and polyvinyl chloride film. From the viewpoint of harmony with the height of the key tops 14, it is desirable for the thickness of the frame sheet 15 to range from 100 μm to 500 μm. When it is less than 100 μm, the frame sheet 15 is subject to cracking. In a more preferred mode, the thickness ranges from 300 μm to 350 μm.

The base sheet 16 is formed of a material that is deflected, when the key tops 14 are depressed, to allow depression of the contact input portions 20 provided on the board 19. Examples of the material include resin films such as polyethylene terephthalate film, polybutylene terephthalate film, polyurethane film, polyamide film, polypropylene film, polystyrene film, fluoropolymer film, ionomer film, polycarbonate film, and polyvinyl chloride film. In order to realize a thin key sheet, it is desirable for the thickness of the base sheet 16 to range from 20 μm to 150 μm. When it is less than 20 μm, the base sheet 16 is subject to breakage. In a more preferred mode, the thickness is 50 μm.

The material of the shape maintaining sheet 17 is a rigid resin film, a metal sheet or the like. In the case of a highly rigid resin film, its flexural modulus is 700 kg/cm² or more. Examples of the resin film include polyethylene terephthalate film, polybutylene terephthalate film, polypropylene film, polystyrene film, polycarbonate film, polyamide film, and polyimide film. In order to attain an enhancement in rigidity and an improvement in depression operability and to realize a thin key sheet, it is desirable for the thickness of the shape maintaining sheet 17 to range from 25 μm to 250 μm. When it is less than 25 μm, the rigidity is rather low, and the shape maintaining sheet 17 is subject to deflection in the surface direction, and when it exceeds 250 μm, the rigidity is rather high, and the depression load is increased, and hence there is a fear of the depression operability being impaired. Further, the key sheet 12 as a whole increases in thickness, and becomes rather hard to mount as a thin key sheet in an apparatus. In a more preferred mode, the thickness is 100 μm. Examples of the metal sheet include a stainless steel sheet and an aluminum sheet. Its thickness is preferably 50 μm or less. When is exceeds 50 μm, the rigidity is rather high, and the depression load is increased, and hence there is a fear of the depression operability being impaired.

The printed adhesive layers 18a, 18b are formed by printing, and it is desirable for the ink forming the printed adhesive layers 18a, 18b to be one that is softened or melted through heating. Examples of the ink include resins, such as acrylic type resin, vinyl chloride type resin, polyester type resin, and urethane type resin, wax, and rubber, which are softened or melted through heating. The ink exhibits fluidity enough to allow printing at the time of coating and properties by which the solid state is maintained thereafter, and it is possible to use a solvent-diluted type ink dissolved or dispersed in solvent, or an ink of the type which is solid at room temperature and which is melted with heat to become liquid. However, since it allows accurate and delicate printing on predetermined surfaces such as those of the key tops 14, and since the solvent is quickly vaporized to leave the ink in the solid state immediately after printing, it is desirable to use a solvent-diluted type ink. Above all, from the viewpoint of suppressing sag and deformation of the printed adhesive layers 18a, 18b during the adhesion process through heating and pressurization, it is desirably to adopt a material of the type which is softened rather than melted through heating. The thickness of the printed adhesive layers 18a, 18b preferably ranges from 5 μm to 50 μm. When it exceeds 50 μm, the requirement for a reduction in thickness cannot be met, whereas, when it is less than 5 μm, control in production is rather hard.

The key sheet 12 as described above is manufactured as follows. First, the key tops 14 are formed by molding, and the frame sheet 15, the base sheet 16, and the shape maintaining sheet 17 are formed by stamping. Next, a colored layer and an evaporation layer (not shown) are provided as needed to form the display portions on the key tops 14. Then, the printed adhesive layers 18a are formed on the key tops 14 and the frame sheet 15 by screen printing, pad printing, relief printing, gravure printing, etc., and the printed adhesive layers 18b are formed on the shape maintaining sheet 17 by a similar printing method. After that, the base sheet 16, the key tops 14, and the frame sheet 15 are matched with each other, and predetermined regions are heated and pressurized from the base sheet 16 side by a thermocompression bonding machine or the like, thereby bonding the base sheet 16, the key tops 14, and the frame sheet 15 to each other. Next, the base sheet 16 and the shape maintaining sheet 17 are matched with each other, and predetermined regions are heated and pressurized from the shape maintaining sheet 17 side by a thermocompression bonding machine or the like, thereby bonding the base sheet 16 and the shape maintaining sheet 17 to each other. In the process from the printing to bonding of the printed adhesive layers 18a, 18b, it is also possible to adopt a method in which the printed adhesive layers 18a, 18b are provided on the base sheet 16 side.

While the conditions for heating and pressurization vary according to the material of the printed adhesive layers 18a, 18b, the thickness of the printed adhesive layers 18a, 18b, the thickness of the base sheet 16, etc., the surface temperature of the pressurized portion ranges from 120° C. to 220° C., more preferably, from 140°C. to 170° C., the pressurization time ranges from 1 second to 20 seconds, more preferably, from 5 seconds to 10 seconds, and the pressure is in the range of 30 kg to 500 kg /20 to 25 cm^{2,} more preferably, 50 kg to 300 kg /20 to 25 cm². While in the above-mentioned example the heating is effected from the base sheet 16 side, it is also possible to effect heating from the key tops 14 and the frame sheet 15 side, and it is also possible to heat and pressurize the shape maintaining sheet 17 prior to doing so on the base sheet 16.

Next, the effects of the key sheet 12 of the first embodiment of the present invention are described.

In the key sheet 12, due to the provision of the shape maintaining sheet 17, the base sheet 16 is not easily deflected in the surface direction. Thus, when depressing key tops 14, the depressed key tops 14 and the key tops 14 adjacent thereto of the frame sheet 15 do not easily move in the operation surface direction in an undulating fashion, and the key tops 14 are relatively free from rising or becoming shaky, making it possible to perform input operation accurately.

Since the shape maintaining sheet 17 has the dividing grooves 17a, the shape maintaining sheet 17 can be easily deflected in the depressing direction. Thus, it is possible to reduce the depression load, making it possible to enhance the tactile feel for the operator. Thus, in the key sheet 12 of the present invention, it is possible to enhance the rigidity in the surface direction without impairing the depression operability.

Since the shape maintaining sheet 17 and the base sheet 16 are fixed to each other by the printed adhesive layers 18b, there is less variation in the positions and area of the adhesive layers when compared with the case in which adhesive is dripped, making it possible to reliably fix the components to each other. Further, the printed adhesive layers 18b are brought into contact with the shape maintaining sheet 17 and the base sheet 16 in a softened or molten state. Thus, when bonding the shape maintaining sheet 17 and the base sheet 16 to each other, it is possible to prevent the printed adhesive layers 18b from being allowed to widely flow and expand in the surface direction of the sheet.

Further, since the printed adhesive layers 18b are formed on the surface of the shape maintaining sheet 17 facing the base sheet 16 except for the edge sides of the dividing grooves 17a, it is possible to provide, around the dividing grooves 17a of the shape maintaining sheet 17, clearance portions 22 devoid of the printed adhesive layers 18b and to utilize the clearance portions 22 as non-constraint portions for the base sheet 16. Thus, when performing depressing operation on the key tops 14, the base sheet 16 can be easily deflected in the depressing direction, making it possible to perform depressing operation reliably on the key tops 14.

Due to the provision of the pushers 21 on the back surface of the shape maintaining sheet 17 on the side opposite to the surface facing the base sheet 16, it is possible to reliably depress the contact input portion 20 on the back side of the key sheet 21 by means of the pushers 21.

Since the thickness of the shape maintaining sheet 17 ranges from 25 μm to 250 μm, the base sheet 16 is not easily deflected in the surface direction, and, when depressing the key tops 14, the depressed key tops 14 and the key tops adjacent thereto do not easily move in the operation surface direction in an undulating manner, and hence the key tops 14 do not easily rise or shake, making it possible to accurately perform input operation.

Since the printed adhesive layers 18a are formed on the surfaces of the key tops 14 facing the base sheet 16 except for the outer edge sides, it is possible to provide the clearance portions 22 devoid of the printed adhesive layers 18a between the adjacent key tops 14 or on the outer edge side of the frame sheet 15 adjacent to the key tops 14, using the clearance portions 22 as the non-constraint regions for the base sheet 16. Thus, when performing depressing operation, the base sheet 16 can be easily deflected, making it possible to reliably perform depressing operation on the key tops 14.

Since the printed adhesive layers 18a are formed by cured bodies held in contact with the key tops in a softened or molten state, it is possible, as stated above, to prevent the printed adhesive layers 18a from being allowed to widely flow and expand in the surface direction of the base sheet 16 when bonding the key tops 14 and the base sheet 16 to each other, thereby enabling to form the printed adhesive layers 18a accurately at predetermined portions of the bottom surfaces of the key tops 14. Thus, it is possible to control with high accuracy the fixed portions and non-fixed portions of the key tops 14 and the base sheet 16.

Since the printed adhesive layers 18a are formed on the surfaces of the frame sheet 15 facing the base sheet 16 except for the outer edge sides, it is possible to provide the clearance portions 22 devoid of the printed adhesive layers 18a on the outer edge side of the frame sheet 15 adjacent to the key tops 14, using the clearance portions 22 as the non-constraint regions for the base sheet 16. Thus, when performing depressing operation, the base sheet 16 can be easily deflected, making it possible to reliably perform depressing operation on the key tops 14.

Further, since the printed adhesive layers 18a are formed by cured bodies held in contact with the key tops in a softened or molten state, it is possible, as stated above, to prevent the printed adhesive layers 18a from being allowed to widely flow and expand in the surface direction of the base sheet 16 when bonding the frame sheet 15 and the base sheet 16 to each other, thereby enabling to form the printed adhesive layers 18a accurately at predetermined portions of the bottom surfaces of the frame sheet 15. Thus, it is possible to control with high accuracy the fixed portions and non-fixed portions of the frame sheet 15 and the base sheet 16.

Further, when a mounting recess 13b is provided on the outer edge of the operational opening 13a formed in the casing of the mobile phone 13, and the outer periphery of the shape maintaining sheet 17 of the key sheet 12 is fixed to the mounting recess 13b by an adhesion layer 13c such as a double-faced tape, it is possible to realize a thin mobile phone 13 with pushbutton switches of superior operability mounted therein. Since no through-hole is provided in the base sheet 16, the base sheet 16 can serve as a seal member, thus providing a waterproof and a dust-proof effect.

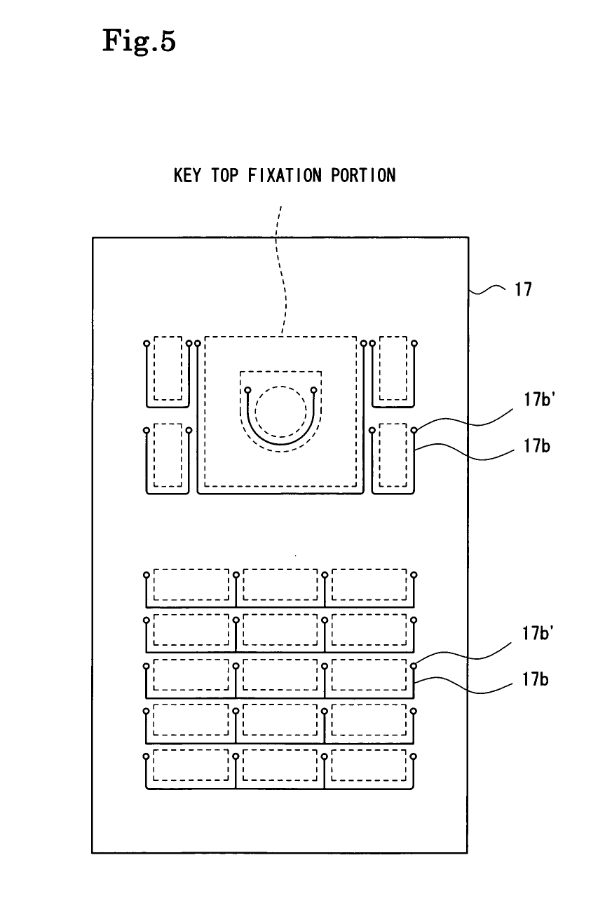

First Modification of First Embodiment (FIGS. 5 through 7): FIGS. 5 through 7 illustrate a first modification of the first embodiment. In the first modification, the configuration of the insulating slits provided in the shape maintaining sheet 17 is changed. That is, instead of the dividing grooves 17a of the shape maintaining sheet 17 provided in the key sheet 12 of the first embodiment illustrated in FIGS. 4A and 4B, insulating slits as illustrated in FIGS. 5 through 7 are adopted.

The insulating slits illustrated in FIG. 5 are formed as cut lines 17b dividing the portions of the base sheet 16 to which the key tops 14 are fixed in a tongue-like fashion. They differ from the dividing grooves 17a illustrated in FIGS. 4A and 4B in that whereas the slits of the dividing grooves 17a have a width, the slits of the dividing lines 17b have substantially no width. Further, round holes 17b′ are formed at the ends of the cut lines 17b, whereby cracks are not easily generated at the ends of the cut lines 17b when the shape maintaining sheet 17 is bent through repeated depressing operation. Like the above-mentioned dividing grooves 17a, the dividing lines 17b can insulate the stress generated through depression of the adjacent key tops 14. Further, the edge portions of the cut lines 17b are in contact with each other, and hence, when compared with the dividing grooves 17a, they can make the shape maintaining sheet 17 less subject to deflection in the surface direction.

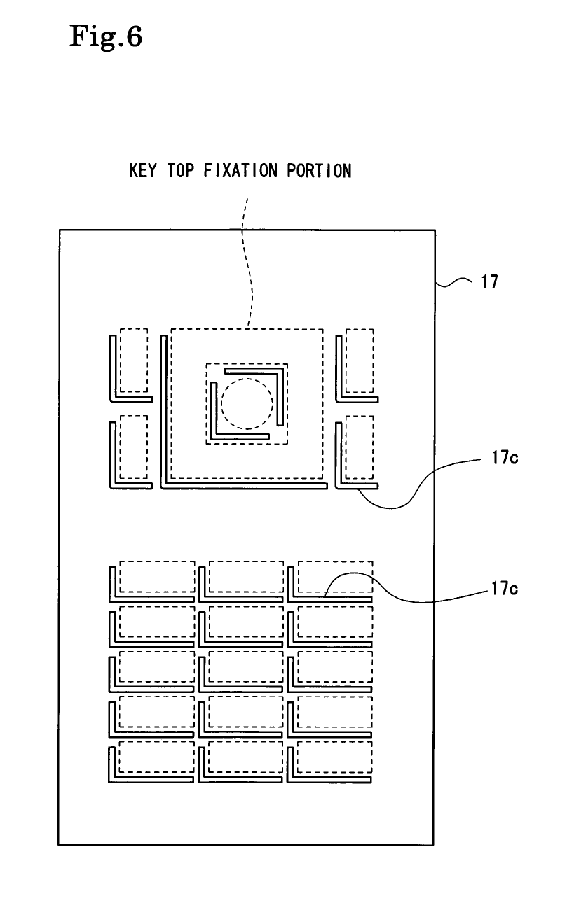

The insulating slits illustrated in FIG. 6 are formed as dividing grooves 17c that are L-shaped in plan view and provided so as to surround the portions where the key tops 14 are fixed. This construction also helps to insulate the stress generated through depression of the adjacent key tops 14.

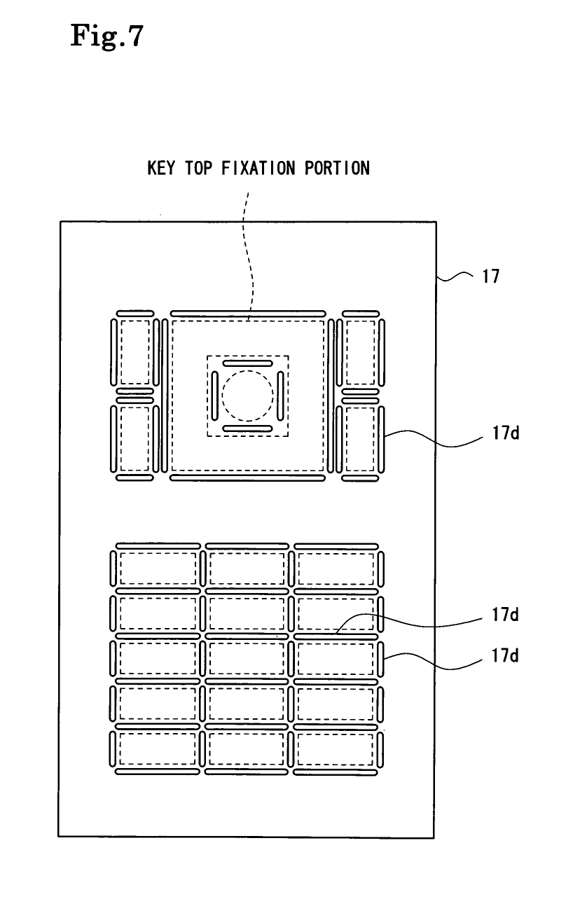

The insulating slits illustrated in FIG. 7 are provided at the four-side positions corresponding to the square configuration of the key tops 14 except for the four apex portions of each square, and they are formed as dividing grooves 17d that are linear in plan view. The dividing grooves 17d are provided so as to surround on four sides each of the portions where the key tops 14 are fixed. With this construction, it is also possible to insulate the stress generated through depression of the adjacent key tops 14.

Second Modification of First Embodiment (FIGS. 1 through 3): a key sheet 31 according to a second modification of the first embodiment has the same construction as the key sheet 12 of the first embodiment illustrated in FIGS. 1 through 3. However, a base sheet 32 of the key sheet 31 of the second modification is formed of a material different from that of the base sheet 16 of the key sheet 12 of the first embodiment.

The material of the base sheet 32 of the second modification is the same as that of the base sheet 16 of the first embodiment in that the base sheet 32 is deflected, when the key tops 14 are depressed, to allow depression of the contact input portions 20 provided on the board 19. However, when compared with the base sheet 16, the base sheet 32 is formed of a material with rubber elasticity that is still more subject to deflection, its hardness being 30 to 99 in JIS K 6253 type A hardness standard. Thus, in this modification, the base sheet 32 has substantially no function to maintain the configuration of the key sheet 31 as a whole. Examples of this material include a resin film with rubber elasticity formed of a polyurethane film with a rubber component alloyed therewith. By using this resin film the base sheet 32 is easily deflected as the key tops 14 are depressed, and is restored due to its rubber elasticity upon canceling the depression, and hence it allows depressing operation to be performed reliably, restoring the key tops 14 to the former positions. The thickness, etc. of the base sheet 32 are the same as those of the base sheet 16 of the first embodiment.

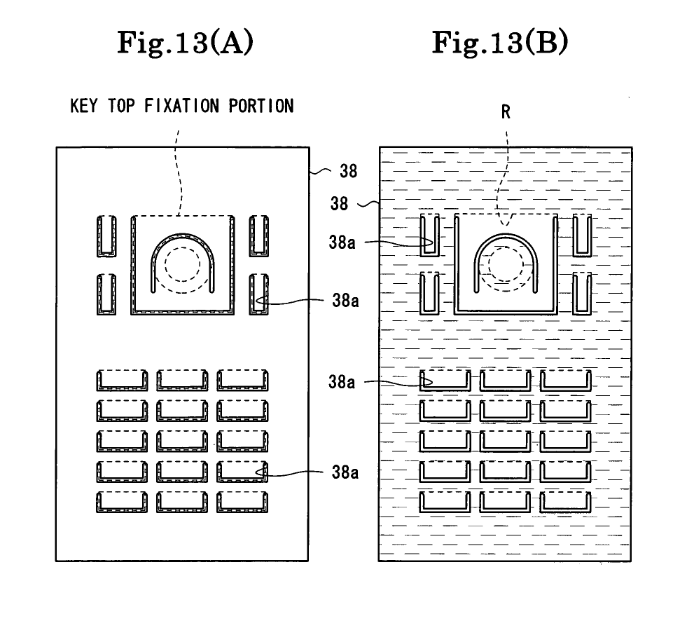

In the key sheet 31 of the second modification, a film of a soft material with rubber elasticity is used. Further, its thickness is so small as to range from 20 μm to 150 μm. However, the shape maintaining sheet 17 is stacked on the base sheet 32 so as to cover the portions of the lower surface of the base sheet 32 corresponding to the portions where the key tops 14 are placed, and hence the portions of the base sheet 32 that undergo deformation are covered with the shape maintaining sheet 17, and the base sheet 32 is relatively free from rupture. In this regard, unlike the conventional key sheet 2 illustrated in FIG. 13, the portions of the base sheet 5 that undergo deformation are not covered with the reinforcing member 6, and hence it differs from the construction which involves a danger of rupture when the base sheet 5 is made thin.

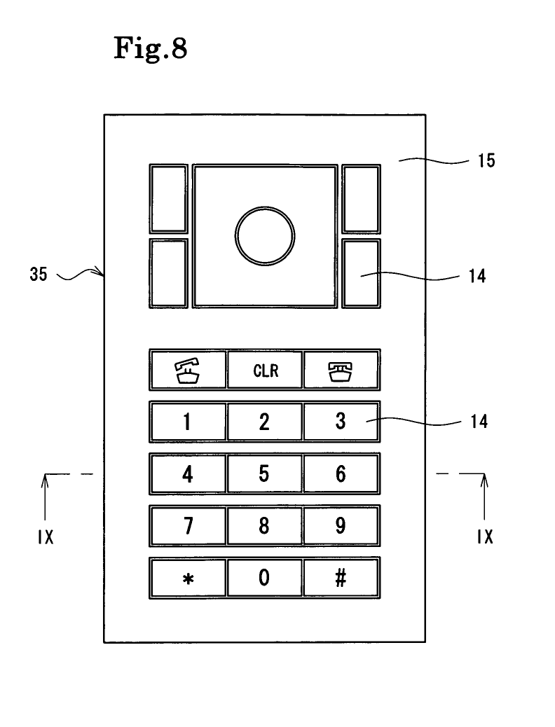

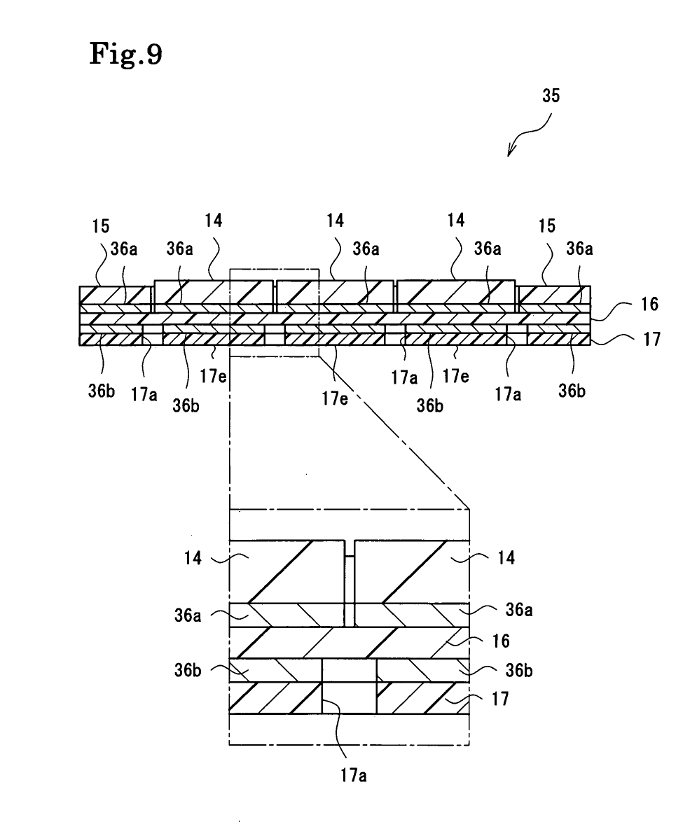

Third Modification of First Embodiment (FIGS. 8 and 9): FIGS. 8 and 9 illustrate a key sheet 35 according to a third modification of the first embodiment. FIG. 8 is a plan view of the key sheet 35, and FIG. 9 is a sectional view of the key sheet 35. The key sheet 35 of the third modification differs from the key sheet 12 of the first embodiment in the construction of printed adhesive layers 36a, 36b. Further, this modification differs from the first embodiment in that the shape maintaining sheet 17 is provided with no pushers 21. Otherwise, it is of the same construction, effects, and manufacturing method as the first embodiment.

The printed adhesive layers 36a are formed on the entire surfaces of the key tops 14 facing the base sheet 16 and on the entire surface of the frame sheet 15 facing the base sheet 16, and the printed adhesive layer 36b is formed on the entire surface of the shape maintaining sheet 17 facing the base sheet 16.

The key sheet 35 is manufactured as follows. First, the key tops 14, the frame sheet 15, the base sheet 16, and the shape maintaining sheet 17 are formed. Next, there are provided as needed coloring layers and evaporation layers (not shown) to form display portions on the key tops 14. Then, the printed adhesive layers 36a are formed on the key tops 14 and the frame sheet 15 by screen printing, pad printing, relief printing, gravure printing or the like, and the printed adhesive layer 36b is formed on the shape maintaining sheet 17 by a similar printing method. After that, the base sheet 16, the key tops 14, and the frame sheet 15 are matched with each other, and predetermined regions are heated and pressurized from the base sheet 16 side by a thermocompression bonding machine or the like, thereby bonding the base sheet 16, the key tops 14, and the frame sheet 15 to each other. Next, the base sheet 16 and the shape maintaining sheet 17 are matched with each other, and predetermined regions are heated and pressurized from the shape maintaining sheet 17 side, thereby bonding the base sheet 16 and the shape maintaining sheet 17 to each other. It is also possible to heat and pressurize the shape maintaining sheet 17 first with respect to the base sheet 16.

The effects of the key sheet 35 of the third modification are described. In the key sheet 35, it is possible to enhance the rigidity in the surface direction without impairing the depression operability. Further, since the printed adhesive layer 36b is formed on the entire surface of the shape maintaining sheet 17 facing the base sheet 16, there is no variation between the portions with and without the printed adhesive layer 36b with respect to the base sheet 16, making it possible for the shape maintaining sheet 17 to maintain the configuration of the base sheet 16 with the entire surface thereof. Thus, it is possible to enhance the shape maintaining effect for the base sheet 16. Thus, accurate input is possible when performing depressing operation on the key tops 14. The portions of the shape maintaining sheet 17 coming into contact with the contact input portions when depressing operation is performed on the key tops 14 constitute depressing portions 17e.

Since the printed adhesive layers 36a are formed on the entire surfaces of the key tops 14 facing the base sheet 16, no gap is generated between the key tops 14 and the base sheet 16, and hence it is possible to make it hard for the key tops 14 to be detached. Further, since the printed adhesive layers 36a are provided on the entire bottom surfaces of the key tops 14, there is no variation between the portions with and without the printed adhesive layers 36a, and it is possible to perform accurate input operation on the key tops 14, making it possible to realize a key sheet 35 of a satisfactory operability. Further, in the case of illumination type key tops, there is no unevenness in illumination due to the provision of the printed adhesive layers 36a on the entire bottom surfaces of the key tops 14, making it possible to provide a key sheet 35 capable of uniform illumination. Further, the printed adhesive layer 36a is formed on the entire surface of the frame sheet 15 facing the base sheet 16, and hence no gap is generated between the frame sheet 15 and the base sheet 16, thus making it hard for the frame sheet 15 to be detached.

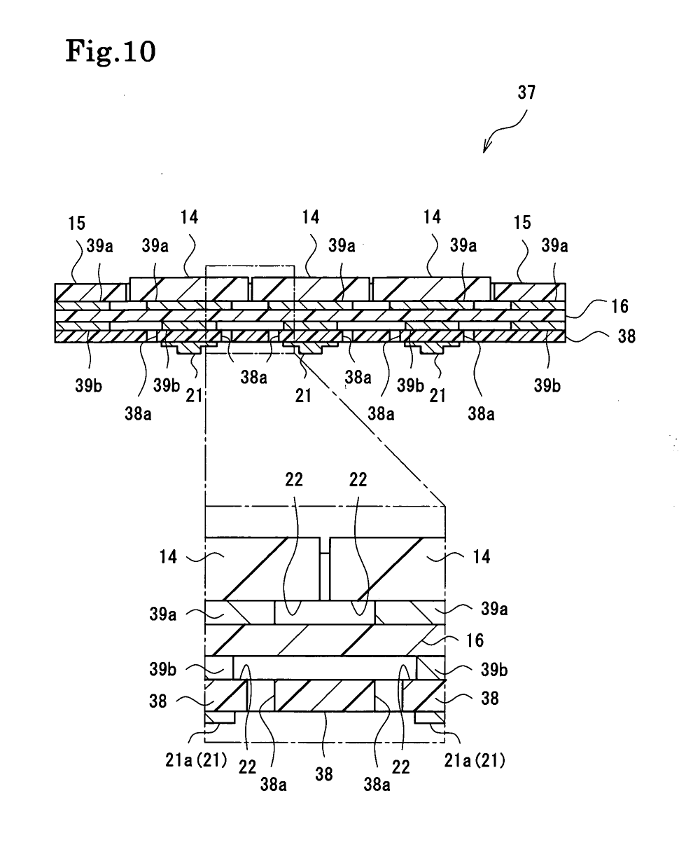

Second Embodiment (FIG. 10): FIG. 10 is a sectional view of a key sheet 37 according to a second embodiment of the present invention. The key sheet 37 of the second embodiment differs from the key sheet 12 of the first embodiment in the construction of insulating slits 38a provided in a shape maintaining sheet 38. Otherwise, it is of the same construction as the key sheet 12 of the first embodiment.

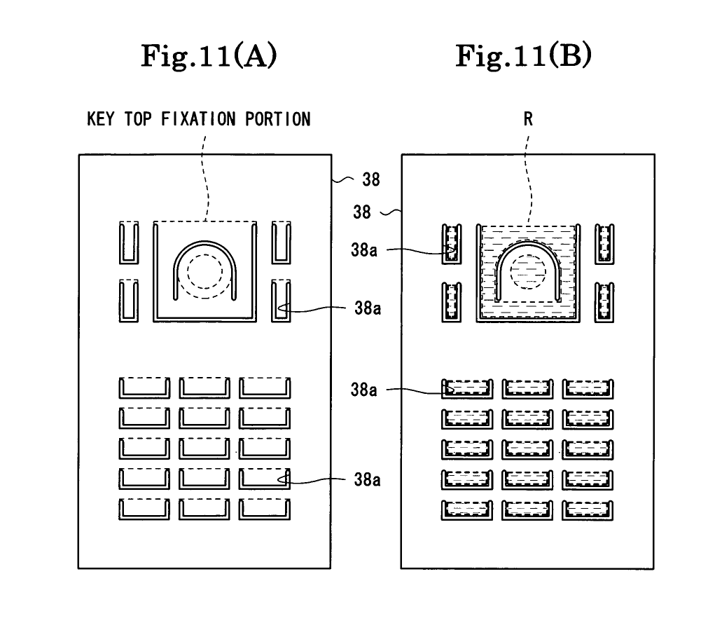

The shape maintaining sheet 38 is stacked on and fixed to the lower surface of the base sheet 16 by a printed adhesive layer 39b described below. Further, the shape maintaining sheet 38 is provided with insulating holes 38a as “insulating slits”. As illustrated in FIG. 11B, the fixation portions R between the shape maintaining sheet 38 and the base sheet 16 are formed individually so as to be divided in a tongue-like fashion. Further, while the insulating slits of the first embodiment are provided at the positions corresponding to the positions dividing the adjacent key tops 14, 14 from each other, the insulating slits of this embodiment are provided within the lower projections of the key tops 14 on the shape maintaining sheet 38.

The key tops 14 and the frame sheet 15 are fixed to the base sheet 16 through the intermediation of printed adhesive layers 39a. The shape maintaining sheet 38 is fixed to the base sheet 16 through the intermediation of the printed adhesive layer 39b. As in the case of the printed adhesive layers 18a of the first embodiment, the printed adhesive layers 39a are formed on the inner sides of the bottom surfaces of the key tops 14 in an area somewhat smaller than the area of the entire bottom surfaces. Further, between the outer edges of the bottom surfaces of the key tops 14 and the base sheet 16, there are provided clearance portions 22 having no printed adhesive layers 39a. Further, no printed adhesive layer 39a is formed at the edge of the frame sheet 15 adjacent to the key tops 14, providing a clearance portion 22 there, too. On the other hand, printed adhesive layers 39b fixing the shape maintaining sheet 38 and the base sheet 16 to each other are provided within the portions surrounded by the tongue-like configurations formed by the insulating holes 38a. Further, within the lower projection of each key top 14, the fixation area of the printed adhesive layer 39b is smaller than the fixation area of the printed adhesive layer 39a. FIG. 11A illustrates the portions where there are provided the printed adhesive layers 39a for fixing the key tops 14 and the base sheet 16 to each other.

The effects of the key sheet 37 of the second embodiment are described. In the key sheet 37, the insulating holes 38a are provided within the lower projections of the key tops 14 without sticking out of those lower projections, and hence it is possible to insulate the stress in the surface direction of the shape maintaining sheet 38, making it easy for the shape maintaining sheet 38 to be deflected in the depressing direction. Thus, it is possible to diminish the depression load, and in the case of a switch with a tactile feel, it is possible to enhance the tactile feel for the operator. Thus, it is possible to realize the key sheet 37 enhanced in the rigidity in the surface direction without impairing the depression operability.

Further, when, as in the case of the key sheet 12 of the first embodiment, the outer periphery of the shape maintaining sheet 38 of the key sheet 37 is fixed, by means of the adhesive layer 13c such as a double-sided tape, to the mounting recess 13b of the operational opening 13a formed in the casing of the mobile phone 13, it is possible to realize a thin mobile phone 13 superior in depression operability and equipped with pushbutton switches capable of providing waterproof and dust-proof effect.

Further, as in the case of the key sheet 12 of the first embodiment, it is possible to replace the base sheet 16 of the key sheet 37 with the base sheet 32 formed of an elastic film. This helps to reduce the depression load at the time of depressing operation, making it possible to achieve an enhancement in operability.

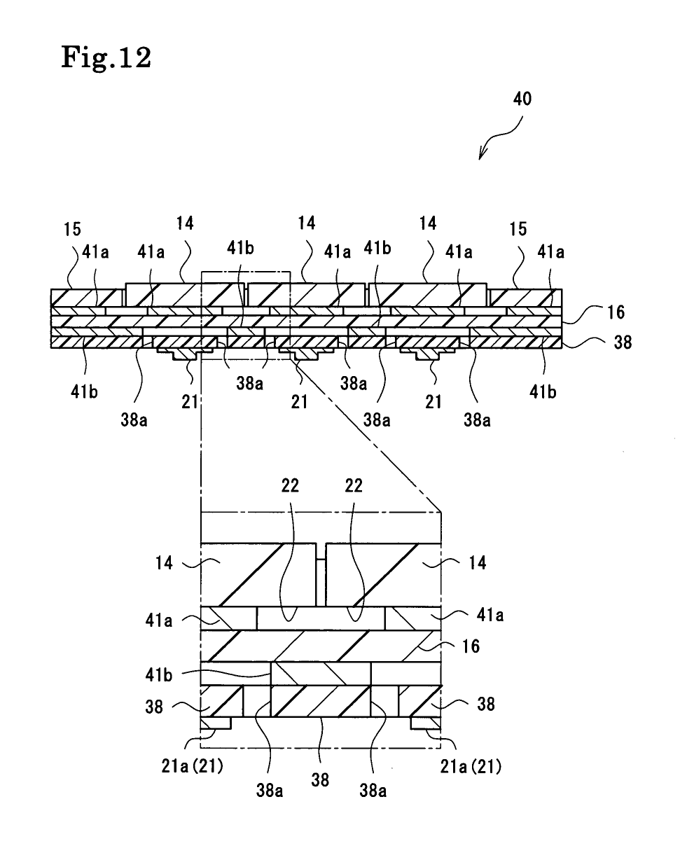

First Modification of Second Embodiment (FIG. 12): FIG. 12 illustrates a key sheet 40 according to a first modification of the second embodiment. The key sheet 40 of the first modification differs from the key sheet 37 illustrated in FIG. 10 in the fixation portions R between the base sheet 16 and the shape maintaining sheet 38, in other words, in the positions of printed adhesive layers 41b fixing them together. That is, as illustrated in FIG. 12 and FIG. 13B, in this modification, the printed adhesive layers 41b are provided outside the tongue-like insulating holes 38a. This helps to enlarge the fixation area between the base sheet 16 and the shape maintaining sheet 38. Further, it makes it possible to provide printed adhesive layers 43b also between the key tops 14, 14, and hence it is possible to utilize the rigidity of the shape maintaining sheet 38 more effectively than in the case of the key sheet 37 described above. Thus, it is possible to further enhance the rigidity in the surface direction of the key sheet 40, making the key sheet 40 less subject to deformation than the key sheet 37. Also in the key sheet 40 of this modification, it is possible to provide clearance portions devoid of printed adhesive layers 41b around the insulating holes 38a, utilizing the clearance portions as the non-constraint regions of the base sheet 16. This makes the base sheet 16 easier to deflect at the time of depressing operation, making it possible to perform depressing operation reliably on the key tops 14.

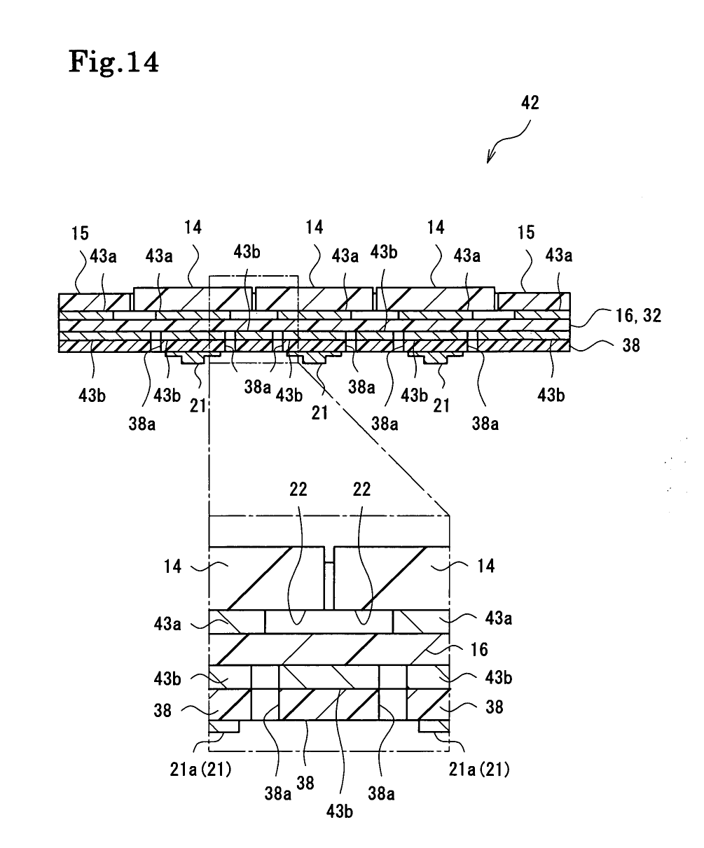

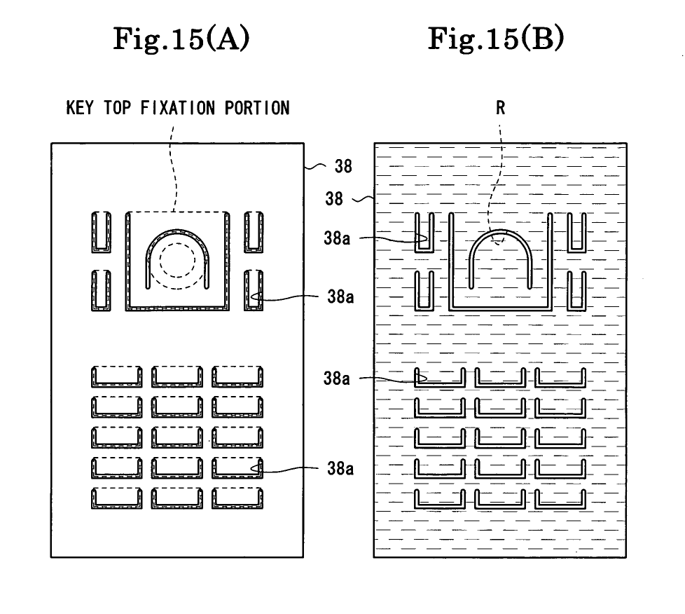

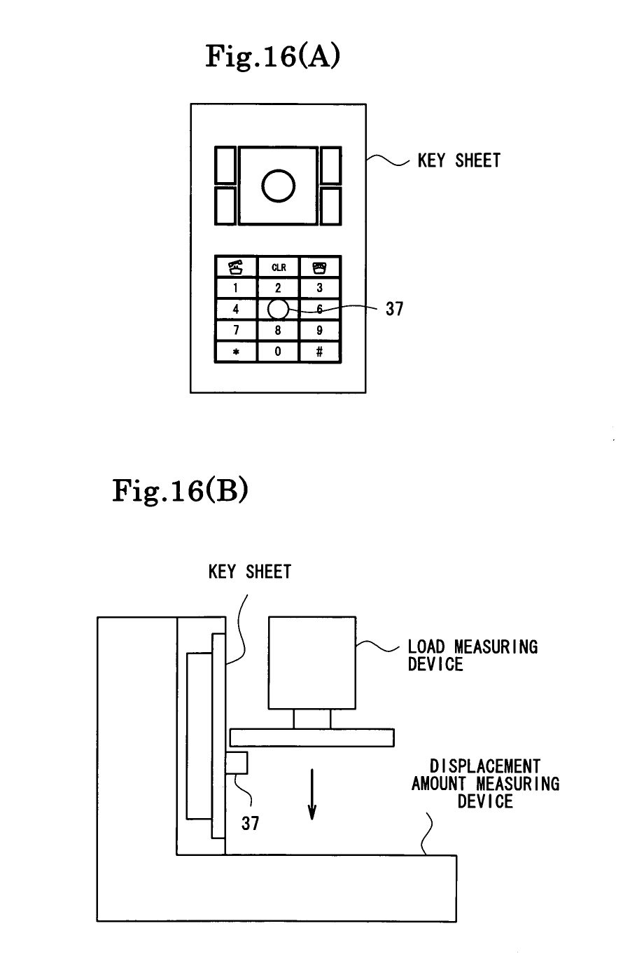

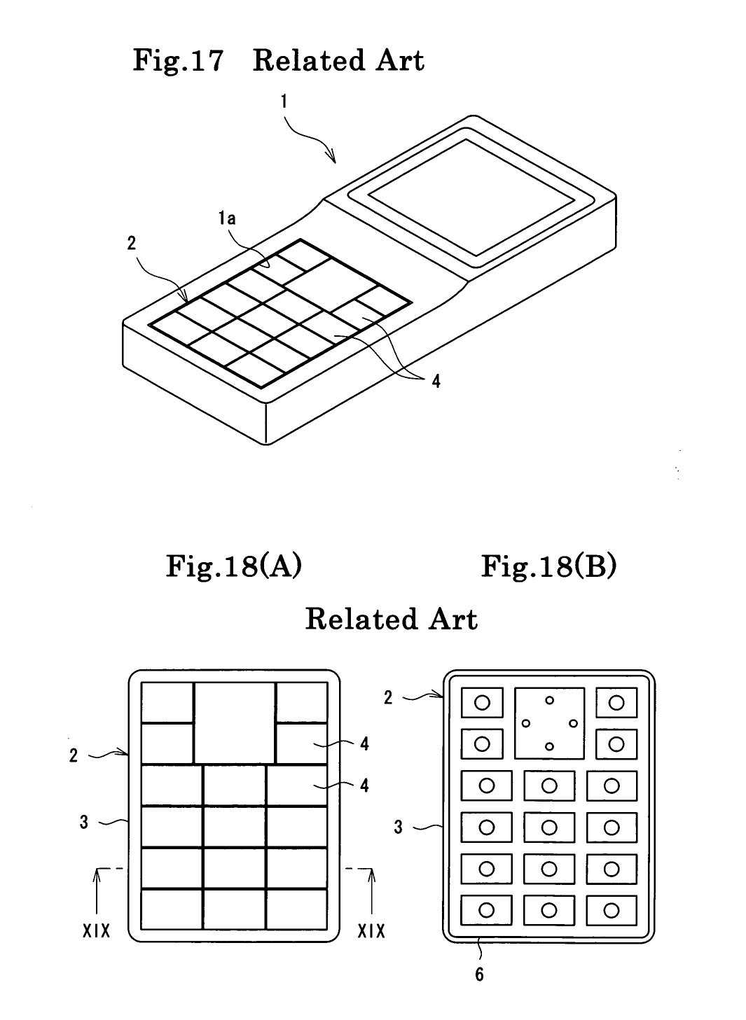

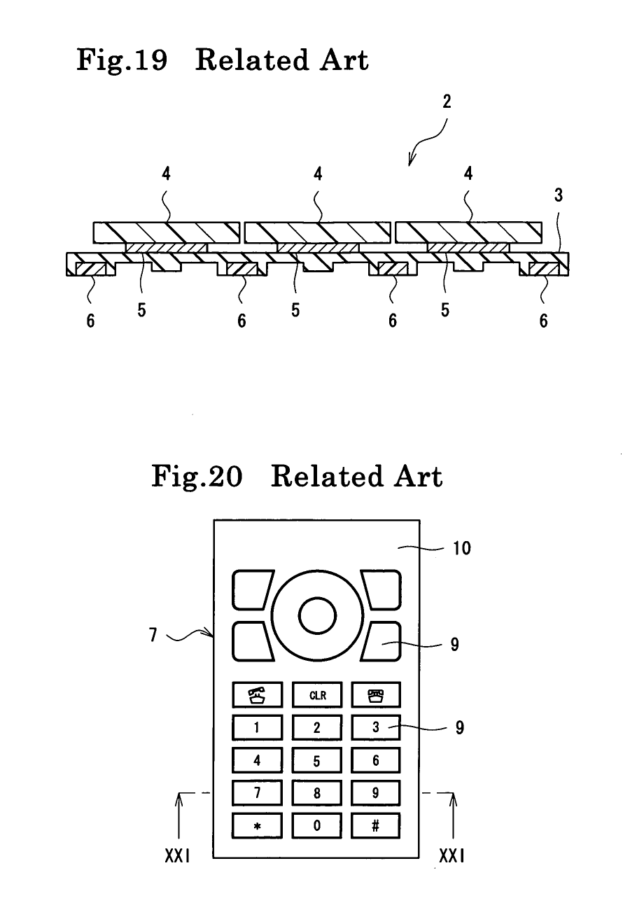

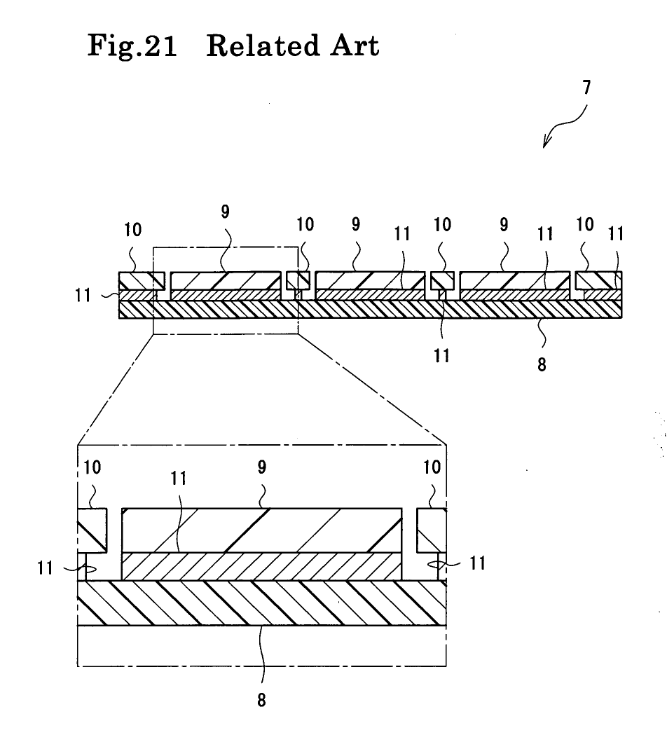

Second Modification of Second Embodiment (FIG. 14): FIG. 14 illustrates a key sheet 42 according to a second modification of the second embodiment. The key sheet 42 of the second modification also differs from the key sheet 37 illustrated in FIG. 10 and the key sheet 40 illustrated in FIG. 12 in the fixation portion R between the base sheet 16 and the shape maintaining sheet 38, that is, in the position where a printed adhesive layer 43b is provided. As illustrated in FIG. 14 and FIG. 13B, in this modification, the printed adhesive layer 43b is provided on the portion except for the tongue-like insulating holes 38a, that is, on the entire surface of the shape maintaining sheet 38 facing the base sheet 16. With this construction, the entire surface of the shape maintaining sheet 38 makes it hard for the base sheet 16 to be deflected in the surface direction, and, when depressing key tops 14, it is possible to prevent the key tops 14 adjacent to the depressed key tops 14 from moving in the operation surface direction in an undulating fashion. Also in the key sheet 42 of this modification, it is possible to provide clearance portions devoid of the printed adhesive layers 43b around the insulating holes 38a, making it possible to utilize those clearance portions as the non-constraint regions for the base sheet 16. This makes it easier for the base sheet 16 to be deflected at the time of depressing operation, making it possible to perform depressing operation reliably on the key tops 14.

Of the key sheets 37, 40, and 42, the key sheet 42 is most free from interference between the key tops 14, followed by the key sheet 40 and the key sheet 37 in descending order. The key sheet 37 involves the least depression operation load and provides the best depressing operational feel, followed by the key sheet 40 and the key sheet 42 in descending order.

Other Modifications: While the above-mentioned embodiments adopt the key sheet 12, 31, 35, 37, 40, 42 having the frame sheet 15, it is also possible to adopt a construction devoid of the frame sheet 15. Further, while in the above-mentioned embodiments the key tops 14 are formed by flake-like hard resin members, it is also possible to form them of soft resin, film, or the like.

In the above-mentioned embodiments, the printed adhesive layers 18a, 36a, 39a, 41, 43 are used for the fixation between the base sheet 16, 32 and the key tops 14 or between the base sheet 16, 32 and the frame sheet 15, and the printed adhesive layer 18b, 36b, 39b, 41b, 43b is used for the fixation between the base sheet 16, 32 and the shape maintaining sheet 17, 38. However, instead of such adhesive layers formed by printing, it is also possible to use adhesive tapes. Use of an adhesive with no base member is preferable since it helps to reduce the thickness of the key sheet as a whole. The thickness of the adhesive tape preferably ranges from 20 μm to 50 μm. When the thickness is less than 20 μm, the shape maintaining property of the adhesive tape is rather poor and the workability in the fixation process deteriorates. When the thickness exceeds 50 μm, the key sheet as a whole is rather thick.

### EXAMPLES

Next, the present invention is described in more details with reference to the following examples, which should not be construed restrictively.

1. Production of the Key Sheet

### Example 1

Using polycarbonate resin, key tops (14) of a thickness of 400 μm were molded. Using a polyethylene terephthalate film, a frame sheet (15) of a thickness of 188 μm was formed, and, using a polyurethane film, there was formed a base sheet (16) having a JIS K 6253 type A hardness of 80 and a thickness of 50 μm. Using a polyethylene terephthalate film of a thickness of 220 μm, there was formed a shape maintaining sheet (17) with dividing grooves (17a) according to the first embodiment. Printed adhesive layers (18a) were provided on the key tops (14) and the frame sheet (15), and a printed adhesive layer (18b) was provided on the shape maintaining sheet (17). Heating and pressurization were performed on the base sheet (16), thereby producing a key sheet (12) constituting sample 1.

### Example 2

The thickness of the shape maintaining sheet (17) was changed to 188 μm, and the other members were formed in the same way as in Example 1 to produce a key sheet (12) constituting sample 2.

### Example 3

The base sheet (16) was formed by using a resin film of the same material with the hardness thereof changed to a JIS K 6253 type A hardness of 96. The other members were formed in the same way as in Example 2 to produce a key sheet (12) constituting sample 3.

### Example 4

The thickness of the shape maintaining sheet (17) was changed to 100 μm, and the other members were formed in the same way as in Example 1 to produce a key sheet (12) constituting sample 4.

### Example 5

The thickness of the shape maintaining sheet (17) was changed to 50 μm, and the other members were formed in the same way as in Example 1 to produce a key sheet (12) constituting sample 5.

### Example 6

The thickness of the shape maintaining sheet (17) was changed to 40 μm, and the other members were formed in the same way as in Example 1 to produce a key sheet (12) constituting sample 6.

### Example 7

The thickness of the shape maintaining sheet (17) was changed to 25 μm, and the other members were formed in the same way as in Example 1 to produce a key sheet (12) of sample 7.

### Comparative Example 1

key sheet of sample 8 was produced without using the shape maintaining sheet (17), forming the other members in the same way as in Example 1.

### Comparative Example 2

A key sheet of sample 9 was produced without providing any dividing grooves in the shape maintaining sheet (17) of Example 4, with the other members being formed in the same way as in Example 4.

2. Key Sheet Evaluation

For evaluation purposes, measurement was performed as follows on each key sheet for click rate, peak load, and rigidity. Table 1 illustrates the measurement results.

“Peak load”: Using a load measuring device, measurement of peak load was performed on each key sheet placed on a board (19) with metal belleville springs (20) arranged thereon. Table 1 illustrates the measured values obtained.

“Click rate”: Using the load measuring device, measurement of peak load and bottom load was performed on each key sheet placed on the board (19) with the metal belleville springs (20) arranged thereon to calculate the click rate. Table 1 illustrates the calculated values obtained.

Formula: click rate=100×(peak load−bottom load)/peak load

“Rigidity”: As illustrated in FIG. 10A, a measurement jig 37 was fixed to the key top with the number “5” of each key sheet, and the key sheet was attached to a displacement amount measuring device. Further, a load of 9.8 N was applied on the key sheet in the operation surface direction (arrow direction) to pressurize the measurement jig 37, thereby measuring the displacement amount of the key sheet. Table 1 illustrates the measurement values obtained.

As illustrated in Table 1, in the key sheets (12) of samples 1 through 7, the peak load is as low as 2.5 N or less, and the click rate is 20% or more, thus providing a satisfactory depression operability. Further, the displacement amount is 1.6 mm or less, which indicates high rigidity of the key sheets. Each of samples 1 through 7 was mounted on a mobile phone (13) and depressing operation was performed thereon, with the result that the key tops (14) did not move in an undulating fashion, with no shaking being generated.

In the key sheet of sample 8, due to the absence of the shape maintaining sheet, the displacement amount is as large as 2.4 mm or more. When it was mounted on a mobile phone (13) and depressing operation was performed thereon, the key tops (14) moved in an undulating fashion, with shaking being generated. In the key sheet of sample 9, due to the absence of the dividing grooves on the shape maintaining sheet, the peak load is as high as 3.0 N or more, and the click rate is as low as 11%, thus indicating a rather poor depression operability.

TABLE 1

| | Shape | Base | Key Sheet | | |
|---|---|---|---|---|---|
| | maintaining | sheet | Peak | Click | |
| | sheet | Hardness | load | rate | Displacement |
| | Thickness (μm) | (type A) | (N) | (%) | amount (mm) |
| Sample 1 | 220 | 80 | 2.46 | 21.8 | 0.88 |
| Sample 2 | 188 | 80 | 2.39 | 23.0 | 0.96 |
| Sample 3 | 188 | 96 | 2.22 | 23.7 | 0.94 |
| Sample 4 | 100 | 80 | 2.18 | 27.5 | 0.95 |
| Sample 5 | 50 | 80 | 2.19 | 28.6 | 1.11 |
| Sample 6 | 40 | 80 | 2.13 | 28.9 | 1.52 |
| Sample 7 | 25 | 80 | 2.20 | 28.6 | 1.20 |
| Sample 8 | — | — | 2.16 | 30.6 | 2.46 |
| Sample 9 | 100 | 80 | 3.20 | 11.0 | 0.84 |

What is claimed is:

1. A key sheet comprising:
a plurality of key tops;
a base sheet having the key tops fixed on an upper surface thereof, with the key sheet being mounted onto a board having contact input portions; and
the key sheet further comprising a film-like shape maintaining sheet stacked on and fixed to a back surface of the base sheet,
wherein the shape maintaining sheet has depressing portions for depressing the contact input portions respectively in correspondence with the key tops, and insulating slits, and
wherein the insulating slits are provided between the adjacent depressing portions, and insulate a stress generated in a surface direction of the shape maintaining sheet when the key tops are depressed.

2. A key sheet according to claim 1, further comprising, on an upper surface of the base sheet, a frame sheet arranged with the key tops.

3. A key sheet according to claim 1, wherein the base sheet is formed as an elastic film with rubber elasticity having a thickness of 150 μm or less.

4. A key sheet according to claim 1,
wherein a thickness of the shape maintaining sheet ranges from 25 μm to 250 μm, and
wherein a maximum thickness of the key sheet as measured from the key tops to the shape maintaining sheet is set to 1.0 mm or less.

5. A key sheet according to claim 1, wherein the insulating slits are formed in a tongue-like configuration in plan view of the shape maintaining sheet.

6. A key sheet according to claim 1, wherein the insulating slits are provided at four-side positions corresponding to a square configuration of the key top in plan view of the shape maintaining sheet except for two or more apex portions.

7. A key sheet according to claim 1, wherein fixation is effected between the key tops and the base sheet and between the base sheet and the shape maintaining sheet by means of printed adhesive layers.

8. A key sheet according to claim 1, wherein the insulating slits are provided within lower projections of the key tops on the shape maintaining sheet.

9. A key sheet according to claim 1, wherein the insulating slits are provided between the depressing portions corresponding to dividing positions between the adjacent key tops.

10. A key sheet according to claim 7, wherein the printed adhesive layer is formed on a surface of the shape maintaining sheet facing the base sheet except for edge sides of the insulating slits.

11. A key sheet according to claim 8, wherein fixation portions between the shape maintaining sheet and the base sheet are, in plan view, at outer positions surrounded by the insulating slits of the shape maintaining sheet.

12. A key sheet according to claim 9, wherein fixation portions between the shape maintaining sheet and the base sheet are, in plan view, at inner positions surrounded by the insulating slits of the shape maintaining sheet.
